(19) United States
(12) Patent Application Publication
(10) Pub. No.: US 2014/0379574 A1
(43) Pub. Date: Dec. 25, 2014

(54) SYSTEM AND METHOD FOR DETERMINING A COST IN ELECTRONIC COMMERCE TRANSACTIONS

(71) Applicant: Riitta RAHKAMA, Tampere (FI)

(72) Inventor: Riitta RAHKAMA, Tampere (FI)

(21) Appl. No.: 13/921,458

(22) Filed: Jun. 19, 2013

(51) Int. Cl. G06Q 30/02; G06Q 20/40

(52) U.S. Cl. CPC G06Q 30/0283; G06Q 20/40
USPC 705/44; 705/39

(57) ABSTRACT

A method for determining a cost in an electronic commerce transaction between a first user and a second user includes at least the steps of continuously or periodically assigning one or more values, based on a set of rules, to at least one entity selected from the group consisting of: first user, second user, and a transaction between the first user and second user, receiving a first user acceptance of a transaction identifying the second user and a first cost and a number of benefits if any, and calculating a second cost based on the first cost, the number of benefits if any, and one or more values corresponding to at least one entity selected from the group consisting of: the first user, the second user, and the transaction between the first user and second user.

### TECHNICAL FIELD

Generally, the invention relates to methods and systems for electronic commerce, and more particularly to methods and systems for managing transactions and information associated with said transactions. Further, the invention relates to commerce involving allocation of benefits and a transaction with an associated cost.

### BACKGROUND TECHNOLOGY

Electronic commerce and online shopping is a fast growing forum of commerce of today. With its growing share and resulting competition, merchants offering goods or services online seek for means of attracting consumers and building consumer-merchant loyalty for example by offering cash back, discounts, reward points or loyalty rewards to the consumers.

In many of the prior art solutions for electronic commerce, the transaction is primar-ily viewed as a payment execution and optional benefits or incentives are narrowly defined secondary objects. Accordingly, consumers seldom receive best incentives available due to lack interest in managing incentives and lack of effective benefit rankings. The level of achievable loyalty towards the merchant and its attraction may suffer because of the remote and nontransparent nature of the connection between the transaction parties.

In some prior art solutions for electronic commerce systems, there may be options for gathering funds for projects or people, or redirecting benefits or rewards to a third party, appointed or suggested by the system administration or the registered user of the system or a merchant providing goods or services for sale on said system. These solutions have in common that they merely (re)direct funds or benefits to one or more objects corresponding to an expression of will or a predetermined fraction of a transaction, that is, there is no influential way to endorse, steer or manage user actions and decisions in every day electronic commerce situations to enable charitable acts and those in need of help to be present where every day consuming naturally takes place.

Social business comprises activities that enable reciprocal and effective intercon-nection of people, information and assets by means of utilizing social media and networks. These connections can effectively influence business decisions, execution and outcome. Social business activities and social media provide powerful tools for creating reciprocity and allowing for influence in electronic commerce relationships.

Social business is creating significant value for organizations and companies in ar-eas of marketing, innovation, operations and leadership. Where organizations gain a better understanding of their customers and their intent, the customers, vendors and suppliers are growingly active in engaging with business, making the social network affiliation bidirectional in its nature and effect. In addition to marketing and adver-tising, the organizations manage their customer relationships through social business activities.

The social business is changing the traditional paradigm, were the main source for offering innovation and corporate image creation has been presumed to be the pro-ducer itself. The social business engagement and bidirectional affiliation thus em-bracing stakeholders is strengthening the influence the customers are having in perceived corporate image creation and as sources of renewal.

Enabling influence into the organization as opposed to merely creating it within the organization can also offer value to the operational performance of the organization among creating a sound basis for managing the corporate image.

Purposeful engagement in social business offers the companies to extend their reach by broadened strategy insight and execution of the same while offering to observe, evaluate and anticipate gradients of the competitive landscape.

To integrate the social business into the organization successfully is also a question of adequacy of provided applications as it is of integration of openness to the organization culture. Obstacles in doing so are manifested in the prior art solutions where measured results for social business activities or metrics therefor, relationship between investment and returns of said activities, are lacking or nontransparent, conflicting the very notion of social media. Potential added value creation and ac-quisition thereof will suffer as a result.

An increasingly important field potentially benefitting of social media is electronic commerce based on technologies such as mobile commerce, electronic funds transfer, supply chain management, Internet marketing, online transaction processing, electronic data interchange (EDI), inventory management systems and automated data collection systems. Electronic commerce is commonly divided to comprise virtual storefronts or malls, demographic data gathering and use through web contacts and social media, business-to-business data exchange (EDI), media utilization for reaching and attracting customers, business-to-business buying and selling and se-curity solutions concerning these transactions.

The prior art solutions for electronic commerce fail to utilize the consumer influence to gain added value in marketing, innovation, operations and leadership. Even further, the prior art solutions for electronic commerce do not provide neither a method nor a system to take further advantage of the social business creating a mu-tually benefitting transaction forum for merchants, consumers and system administration, where pricing and rewarding is transparent and foreseeable, thus enabling a greater degree of influence on decision making and influence of actions of the parties.

### SUMMARY OF THE INVENTION

It is an object of the present invention to implement such a solution, that previously mentioned drawbacks of the prior art could be diminished. The present invention is a method and system for managing transactions and information associated with said transactions. In particular, the present invention is implied to provide a feasible solution to manage allocation of benefits in connection with transactions. Further, it is the object of the present invention to describe a method to determine a transaction cost that is influenced by the decision and actions of the transaction parties. The invention is implied to solve how decisions and actions taken by customers and merchants can be defined as a measureable influence. A further aspect of the present invention is to define said transaction cost as constituting a reverse refund model, the said model taking in to account said measureable influences.

The transactions may involve accumulation and/or redemption of money and/or benefits and one or more accounts for money and/or benefits. Money is used herein to refer to government issued currency and equivalents thereof, whether in the form of cash, digital money, bank accounts, electric funds and other money exchanged electronically. Benefits refer herein to objects that may be exchanged for money, products and/or services, thus having a value. Benefits may expire, may be assigned an exchange rate relative to money and/or may be subject to other rules that differ from laws governing the accumulation and exchange of money.

The system of the present invention has operative involvement with a number of parties comprising of one or more subscribers with a user account to the system according to the present invention, one or more merchants accepted to present goods and/or services via the system according to the present invention, optionally one or more benefit providers maintaining and administrating benefits associated with specified objectives, rules or criteria via the system according to the present invention, optionally one or more third party beneficiaries made eligible for receiving benefits, one or more payment providers processing authentication and payment requests and a communication network providing access between the above mentioned parties and systems, a network such as telecommunication, internet, semantic web or other wireless or wired network access and any combination of these constituting an access network.

The subscriber may access a dedicated account in the system according to the present invention using a terminal possessing the application and user interface according to the present invention and connected to said system by the before mentioned communication network. The terminal can be a personal computer, a mobile electronic device or other arrangement readily understood by those skilled in the art of computers and telecommunications.

The subscriber account is structured manually and/or automatically to represent the subscriber's personal profile including information such as personal data, financial data, consuming and benefit preferences and charity preferences. The accessing terminal application and interface is the authenticating means to access said account, to convey requests to said system and to receive information from said system. Further, receiving information from the system may be initiated according to a request conveyed by the subscriber or automatically initiated by the system based on operative involvement of other system parties and/or a combination of the subscriber's present actions, past actions and/or preferences. Automatic initiation may be based on techniques such as data mining, semantic and other applicable forms of data processing. The representation of the received information presented at the terminal interface depends on the application settings and subscriber's profile.

The subscriber may convey request such as to register an account, changing personal account profile information, searching and viewing goods, services, merchants, benefits, benefit providers and/or eligible beneficiaries. Further, the subscriber may convey a request including an intent, such as being interested in a charitable action, benefit offering and/or an expression of will to acquire goods, services and/or redirecting funds to a third party.

A merchant accepted to present goods or services for sale on the system according to the present invention may do so by the system having searchable data identifying the merchant and data presenting goods and services offered by said merchant, the data optionally being links to other systems storing the associated data describing the merchant, goods and/or services. A merchant may also search, view or be presented with interests and intents of subscribers, thus being able to react to demand by presenting existing or new products and/or services meeting the demand. Further, the system includes means to store benefit offering plans, charity objects and programs and means to link a merchant to one or more of said plans, objects and programs. Even further, the system may establish a transparently visible sustainability index to one or more merchant. The sustainability index is calculated by the system from measured influences of actions of the merchant and consumer assessments regarding said merchant.

The system may have searchable data identifying a benefit provider party. Said party keeps available, maintains and administrates benefit objects accepted to fund, wholly or partially, selected services or goods, enabling the beneficiary to acquire said services or goods, according to specified objectives, rules or criteria. The objectives, rules and criteria may reflect social, legal, ethical, equal service offering and other welfare objectives of the society. The benefit provider may be a charitable organization, interest group, a governmental or public administration institution etc.

The system may have searchable data identifying third party beneficiaries. This data may identify attributes of the parties, such as their eligibility to a benefit and/or their need for a service or goods accepted to be funded at least partially by a benefit object.

The system further has an established connection to one or more payment providers, such as banks, credit card companies, telephone carriers, trade and commerce pay-went commission systems etc. for processing authentication and payment requests generated in the system according to the present invention.

The method according to the present invention discloses a procedure for determining a cost in an electronic commerce transaction between a first user and a second user, comprising at least the steps of
continuously or periodically assigning one or more values, based on a set of rules, to at least one entity selected from the group consisting of: first user, second user, and a transaction between said first user and second user,
receiving a first user acceptance of a transaction identifying the second user and a first cost and a number of benefits if any, and
calculating a second cost based on the first cost, the number of benefits if any, and one or more values corresponding to at least one entity selected from the group consisting of: the first user, the second user, and the transaction between said first user and second user.

The transaction may be associated with a purchase of products and/or services, but according to the present invention, the transaction may also exclude a purchase of a product and/or a service. In such a case the transaction is a donation or a redirection of benefits or a process of acquiring benefits to which the user is eligible for.

The number of benefits if any may include the possibility of no benefits associated with a value corresponding to zero exchange value and no beneficiaries, which then affects the calculation of the second cost accordingly.

The system according to the present invention discloses an arrangement for determining a cost in an electronic commerce transaction, comprising
database for storing one or more values for at least one entity selected from the group consisting of: first user, second user, and a transaction between said first user and second user,
an evaluation entity for continuously or periodically assigning one or more values, based on a set of rules, to at least one entity selected from the group consisting of: first user, second user, and a transaction between said first user and second user,
a communication entity for presenting information from said database based on a received user request or a system request and to convey information to said database based on a received user request or a system request,
a payment entity for processing a transaction request based on a first user request accepting a transaction identifying the second user, a first cost and a number of benefits if any, and associated evaluations in said database, said processing comprising a computation of a second cost and a payment transfer.

The second transaction cost may be limited to never assume a negative value that is, a value of the second transaction cost less than zero may be interpreted as being equal to zero. A second transaction cost less than zero may in some circumstances be preferred to be interpreted as generating a corresponding payment from the service provider towards the merchant.

The price of the product or service is optionally payable by a subscriber at least partially with benefits earned from other transactions or assigned to her by an operationally involved party of the system, such as a benefit provider verifying the subscriber's eligibility for such a benefit or another subscriber of the system assigning accumulated benefits to the subscriber.

The first transaction cost is a cost defined by an agreement between the merchant registered to the service and the service provider. The cost can be defined per each made transaction, for example an agreed fraction or percentage of the price of the product or service, and/or a monthly or yearly fee or some other applicable arrangement of service cost establishment and scheduling.

A payment transaction is generated by the system, where the due price of the product or service is redirected to a payment provider initiating the payment transfer from the subscriber to the merchant. The merchant effects the payment of all the benefits applicable to said transaction either so that the benefits are deduced from the product/service price before the resulting payment is transferred to merchant or the unabridged payment is transferred to the merchant and the benefits are invoiced from the merchant's account. The effect of payment of all the applicable benefits of the actualized transaction can also be any combination of afore mentioned arrange-ments and can involve the transfer of money and/or benefits.

There may be one or more evaluations made by the system involving the transaction parties and the transaction. For example, actions of the subscriber, such as the share of giving away of accumulated benefits and optionally the evaluation of the received product or service (present transaction evaluation) by the subscriber may be evaluated to determine a first fraction assigning a value between and including a first minimum and maximum. Further as an example the quantity and target of assigned benefits by the merchant in said transaction and a sustainability index of said merchant, defined by the past transaction (inter partes by the subscribers) evaluations and system (ex partes system administrator coordinated) evaluations (e.g. certificates etc.) may be evaluated to determine a second fraction assigning a value between and including a second minimum and maximum, the sum of said first and second maxima in this example being preferably equal to one.

The fraction or percentage, implied by the sum of determined fractions, of the benefits made payable by the merchant in said transaction, is refunded by the service provider by deducing said sum or value of benefits multiplied by the sum of said fractions from the first transaction cost, a subtraction of said refund from said first transaction cost defining a second transaction cost remaining at the system administrator, and generating a reversed transaction, refund or cost reduction to the merchant defined by the difference between said first transaction cost and the second transaction cost.

A transaction according to the present invention may include one or more purchase requests between the subscriber and one or more merchants, where each constituting purchase transactions is determined a first and second transaction cost as described in the present invention. The method according to the present thus supports fragmented buying paths and virtual store fronts. Further, a transaction purchase request between a subscriber and a merchant may include one or more purchase requests between the merchant and one or more subcontracting third parties where each constituting purchase transactions is determined a first and second transaction cost as described in the present invention. The method according to the present invention thus supports co-creation and outsourcing and enables a value network creation with its transaction cost model.

Advantages of the present invention are expressed in a service the system and method of the present invention enables, where a semantic intent in the transaction model creates the demand of the customer. The merchant creates the supply in the transaction model and when the demand and supply meet, the acceptance of the customer initiates the transaction. The customer profile and application settings define, how the application is utilized and where and to which extent offered benefits are addressed. The customer may receive or redirect benefits and may at least partially make a payment using applicable benefits including benefits from a benefit provider such as the public sector. The transaction model is adapted to integrate fragmented purchase paths of multiple providers in the system. The transactions determine refunds that the system addresses. The reversed funding model creates a co-creating service design and quality assurance, where transaction inter partes (customer assessment) and transaction ex partes (system assessment) measurements enable the value network growth and profitability assessment. The reversed transaction targets refunds to beneficiaries addressed by the system administration or the value network parties. Taking in to the account applicable laws and statutes, ethics and trans-parency and regional cultural aspects, the system communicates, integrates, calcu-lates, measures, documents and influences operationally involved parties' transactions, assessments, metrics, quality and benefit actions. The system may, based on allowance, create content to social media to promote sustainable growth and certify parties' sustainability indexing. Ultimately this means that in a service the system and method of the present invention enables the highest indexed and best quality providing customer-provider combinations are free from transaction cost and all benefits are directed to third party beneficiaries without surcharge.

The motivating force of the system is the type of action that is endorsed by metrics of the system. Undertaking benefit programs that in quality, quantity and objectives are endorsed by the metrics of the system by assigning high value evaluations lead to reducing transaction costs for the merchant as the merchant is able to finance an increasing share of provided benefits with refunds of the first agreed transaction or service cost. Even further this trend makes even better benefit offerings feasible by the decreasing transaction cost or increasing refunds which leads to an increased potential to attract more customers and gain loyalty of the customers by sustainable and charitable activity and attitude shared with the customers.

The objective of the invention is met by the features disclosed in the independent patent claims.

Some preferable embodiments of the invention are described in the dependent claims.

### SHORT DESCRIPTION OF THE DRAWINGS

Next, the invention is described in more detail with reference to the appended drawings, in which

FIG. 1 illustrates a transaction process according to one embodiment of the present invention.

FIG. 2 illustrates a prior art transaction process.

FIG. 3 illustrates a transaction process according to one embodiment of the present invention.

FIG. 4 illustrates a transaction process according to one embodiment of the present invention.

### DETAILED DESCRIPTION OF THE EMBODIMENTS

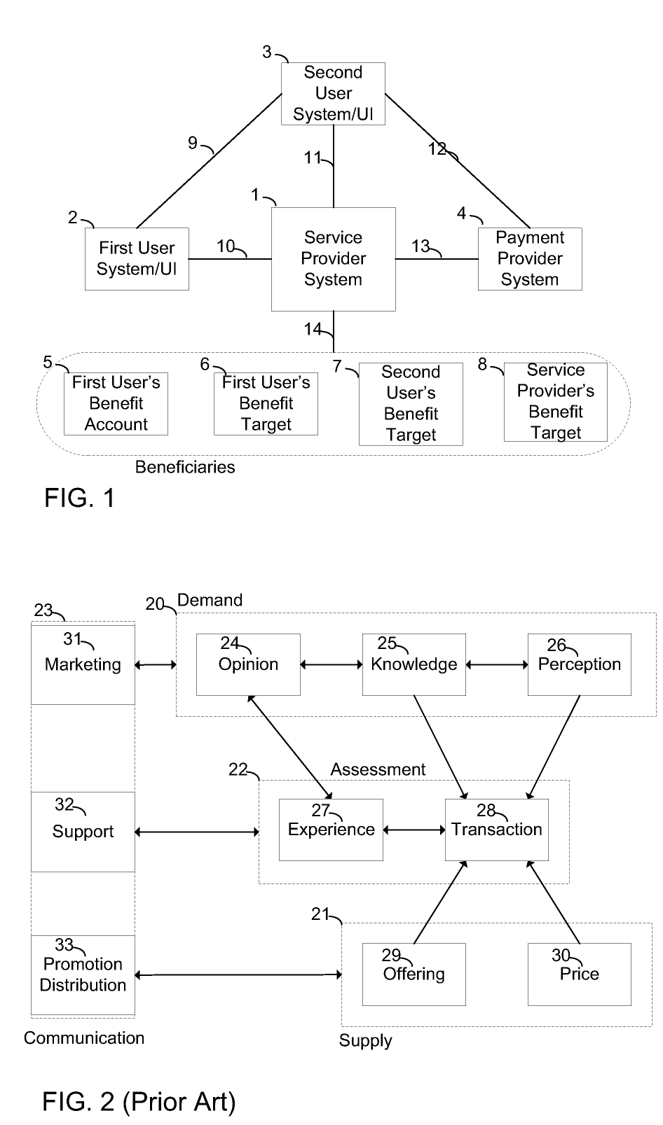

FIG. 1 illustrates an exemplary service provider system 1 according to the present invention and an exemplary combination of operationally involved parties 2-8 of said system. The indicated arrows 9-14 depict access between said system and parties, provided by the communication network such as telecommunication, internet, semantic web or other wireless or wired network access and any combination of these.

In FIG. 1 a first user 2 may communicate with a second user 3 via a provided connection 9 to purchase a product or service supplied by the second user. The second user may indicate that one possible payment method for the first user is to use service provider system 1 with a certain amount of benefits assigned to a beneficiary 7 as a result of the transaction payment. By choosing this payment method, the payment request is transferred via connection 11 to the service provider system, which processes the payment via connection 13 to a payment provider system 4 and assigned benefits for example being a charity program in benefit targets 7 are transferred. Additionally, there may be on option of the first user receiving a benefit 5 which the first user may choose to at least partially assign to a benefit target 6 of her choice. A transaction cost, determined as disclosed in the present invention, is directed from the second user 3 to the service provider system 1 and at least partially further to a benefit target 8 determined by the service provider system. The transaction of this example does not necessarily have to include a purchase of a product or service, but may instead be an assignment of a benefit to a user or charity program assigned to 6 or 7 through a benefit providing (transferring) second user and the service providing system.

Further, the second user 3 in FIG. 1 may be a benefit provider and by communicating over the connection 9, the eligibility of the first user 2 for a benefit, for example receiving a health care operation paid in full by the benefit instruments provided by the benefit provider may be established. The second user can then communicate over a connection 11 with the service provider system 1 to direct said benefits with a targeted use (use limitation) via a connection 14 to the first user's benefit account 5 (the first user being thus a beneficiary). After receiving the treatment, the health care may either invoice the first user, which effects the payment by appointing the appropriated benefits or the invoice may be targeted to the second user (benefit provider) that effects the payment by reducing the amount of benefits granted to the first user for health care by the amount of the invoice.

Even further in FIG. 1 a first user 2 may visit the service provider system 1 user interface over the internet connection 10 using a laptop, mobile device or a tablet. The first user may visit the service provider service pages on internet to view for example different charity objects, products and services or merchant information and certificates.

In this exemplary embodiment if the first user is a subscriber of the service provider system, she may sign in to the service user account. The subscriber may define the beneficiaries 6 she prefers to support. The preferences are stored to the system database. The database also contains information regarding benefits 5 that are earned in transactions or being assigned to the first user by a benefit provider or another user. The subscriber can view her accumulated benefits and their usage and redirection to beneficiaries and charitable objects using the system user interface connection 10 and 14.

In FIG. 1, the second user 3 being a merchant can define preferred or supported beneficiaries 7. For example, this may be a bonus account arrangement for its customers or a fractional donation per each transaction to a nature conservation program or organization.

In FIG. 1, the first user may select through the user interface 10 an offering of a merchant or optionally define her demand in the service provider system as “if something like this would exist, I would buy it”. The demand may have attributes and criteria such as product or service type or category, price range, brand, qualities, details and design of the product or service etc.

Placing a demand in the service provider system creates a preorder and its attributes and criteria may also include obtainable benefits and the allocation of benefits or donations. The preorder may also exclude the trade of a product or service, thus merely defining a beneficiary to receive a benefit, the benefit optionally including purpose of use or limitation of use.

The preorder is stored in the system database. If the subscriber has defined preferred merchants and/or beneficiaries, the service provider system communicates information of the demand or need and/or allocated benefits to the associated parties. In the case the subscriber has not defined any particular supply providing party and/or beneficiary objects the service provider system can display or keep in a searchable form a representation of the preorder demand with associated attributes, criteria and terms over the connection 11. The system may also suggest supply providing parties and beneficiary objects based on said attributes, criteria and terms and optionally based on the user account settings and information and prior actions of the subscriber.

One or more merchants and/or eligible beneficiaries may respond to the preorder from which responses the subscriber may at her will accept an offer associated to a response best suiting the perceived need and preferences of the subscriber. The acceptance is communicated by the system to the merchant and/or beneficiary parties of the accepted offer constituting an order of a product or service and/or allocation of benefits.

The merchant system establishes a secured connection 11 over the internet to communicate the transaction information to the service provider system. The service provider system receives the payment request and creates an identifier for the transaction for monitoring the transaction and allocation of benefits.

By using the service provider system user interface and being signed in to her account, the subscriber can define what means of payment she prefers to use, indicating the method of payment from a choice of payment methods the subscriber has associated to the service account, such as money, electronic wallet, accumulated benefits, bank accounts, credit cards accounts etc. or any combination thereof. Using a benefit account 5 to at least partially effect the payment may be arranged so that the actual payer is a party different from the subscriber, the benefit optionally including purpose of use or limitation of use and an assigned paying party effecting the payment being a benefit provider (or another subscriber).

A payment transaction is generated by the system payment processing entity, where the due price of the product or service is redirected by a connection 13 to a payment provider 4 initiating the payment transfer 12 from the subscriber to the merchant. The merchant effects the payment of all the benefits applicable to said transaction.

The linking of the purchase request and payment request, according to the present invention, initiates the fulfillment of payment of the benefits applicable to the real-ized transaction. The payment of benefits may be executed by subtracting the value of the benefits from the product/service price associated with the payment request or by invoicing the merchants account.

The benefits are transferred by the system to the assigned beneficiaries and the merchant is informed of the processed payment.

The subscriber may be reserved with an opportunity to review a received product or service and an evaluation based on the review is made by the service provider system. The review may be made visible at the service provider system.

As an example, after receiving a service or a product, the customer may review the service or product and/or the merchant, for example, how well the supply met the demand, either using a media platform, such as social media, or a questionnaire provided by the service provider system. The review may include an exact outcome, as choosing a value from 0 to 5 according to how well the supply met demand. Further, the review may constitute of an review in writing possibly including terms such as bad, good, excellent, mediocre, unsuitable etc. and/or value representation such as “10”, “100%”, “2 of 5”, zero etc., characters such as one or more stars symbols, smileys etc. These can be transformed by the system to a number by a semantic assessment or a request to the customer to specify a number representing the review. The resulting number can be mathematically scaled or mapped to a range of fractions.

A person skilled in the art will find that any applicable way of rating or certifying a product or a service to express predefined qualities of said product or service may be utilized in connection with the present invention.

Likewise, the merchant may continuously or periodically be evaluated by the service provider system, which is maintaining a displayed sustainability index of the merchants. This evaluation may take into account the targets and the amounts of benefits provided by the merchant. The evaluation may also include other evaluations, such as financial, social responsibility, ethical etc. evaluations existing on the merchant.

For example, the merchant may be associated with a rating or certificate in the service provider system. This rating or certificate may be assigned numerical value. As an example, the amount of cumulative, monthly, yearly or per transaction benefits provided by the merchant, optionally weighted by a multiplier representing the beneficiaries, may result to a number, which by scaling or assigning a number according to intervals or defined limits, can mathematically defined to assume a repre-sentative fractional value.

A person skilled in the art will find, that any applicable way of rating or certifying a merchant to express predefined qualities of said merchant may be utilized in connection with the present invention.

Optionally, the system may evaluate its subscribers, for example on the basis of the share of giving away received personal benefits and donations to charity.

As an example, the subscriber may be associated with a rating reflecting the cumulative amount of benefits provided by the subscriber to other subscribers, beneficial-ies and benefit programs. The average share of redirected benefits of all received benefits of each transaction the customer has made can be mathematically scaled or mapped, linearly, logarithmically or in some other preferable way, to a range of numbers.

Accordingly, as an example, a numerical representation is determined by the system, wherein said number is

$$f = \frac{{\sum }_{i = 1}^{n} {w}_{i} {s}_{i}}{{\sum }_{i = 1}^{n} {w}_{i}} ,$$

where wᵢ is describing the level of financial dependence on contributions of the benefit receiving party, sᵢ is a share of allocated benefits to the benefit receiving party of all received benefits, the equation defining a number f as a weighted average of the shares the customer has provided to others from the benefits acquired. The weight wᵢ may, as an example, be given a value 0, if the benefit receiving party is a regular subscriber not listed as a charity beneficiary by the system. Further, a beneficiary deemed not able to pay for basic need related necessities or not receiving equal service in health related services may be assigned an importance weight of 1. Assuming each of the shares sᵢ represent the share of redirected benefit relative to the total benefit as a number in the range of 0 to 1, a further mathematical scaling f′=a·f,0<a≦1, yields a fraction f′ in the range from 0 to a.

A person skilled in the art will find, that any applicable way of rating or certifying a customer to express predefined qualities of said customer may be utilized in connection with the present invention.

A person skilled in the art will further find, that many aspects of the service according to the present invention and its operationally evolved parties may preferably be evaluated by using any advantageous and feasible mathematical mapping, semantic evaluation, logical determining or deterministic assigning, only to name a few pos-sibilities, to enable a way to evaluate the quality of the service and adherence of the operationally evolved parties to the valuations of the service. Further, according to the present invention, said evaluations enable the system to achieve endorsed effects by directly and indirectly rewarding the parties that adhere to the valuations of the system. Even further, by using existing and future platforms, media and communication means, the evaluations benefit from reaching the multitude of forums and means where diversified representations of views and actions are present and can be processed to evaluate influential aspects of actions and decisions taken by different parties. Bringing these evaluations in use in connection with the system and method of the present invention enables many beneficial embodiments of the invention.

FIG. 2 illustrates an exemplary prior art transaction environment with fragmented information sources, where by integrating the demand 20, supply 21, assessment 22 and communication 23 entity information at least partly to the service provider system according to the present invention increases the influence and importance of opinions 24, experiences 27 and perception 26 in addition to knowledge 25 residing in a modern information society user community to guide marketing 31, support 32, promotion and distribution 33 and shape the offerings 29 and pricing 30 of the suppliers even further that commonly done. The present invention discloses a method and system for managing transactions and information associated with said transactions in existing and future transaction environments and platforms. Further, it is the object of the present invention to describe a method to determine a transaction cost that is influenced by the decision and actions of the transaction parties, having a controlling effect by endorsing predefined valuations. The invention is implied to solve how decisions and actions taken by users, for example customers and merchants, can be defined as a measureable influence. A further aspect of the present invention is to define the transaction cost as constituting a reverse refund model, the said model taking in to account said measureable influences.

To enable the essential aspects of the present invention, one or more fractions may be defined as numbers in the range from 0 to 1 and further scaled so, that the sum of the maximum values each of the fractions may assume is a predetermined number, such as 1 in one preferred embodiment of the present invention. A first transaction cost is determined, which is based on an agreement between the service provider and the merchant. Based on the evaluations made by the service provider system, a second transaction cost is calculated, being less or equal to the first transaction cost. The second transaction cost remains at the service provider system and may further be at least partially assigned to beneficiaries. The difference between the first and the second transaction cost is refunded to the merchant to fund benefit offerings.

In one preferred embodiment of the present invention, the second transaction cost may be calculated as the difference of the first transaction cost and the product of the value of the transaction benefits and the sum of the evaluation fractions,

$${c}_{2} = {c}_{1} - ( {\sum }_{i = 1}^{m} v ( {b}_{i} ) ) \cdot ( {\sum }_{j = 1}^{n} {f}_{j}^{′} ) ,$$

where c₁ is the first transaction cost, c₂ is the second transaction cost, ν(bᵢ) is the value of a benefit bᵢ and f′ⱼ is a scaled fractional value or a number based on an evaluation. Further, optionally c₂ may be interpreted so, that a negative second transaction cost has a calculation value of zero. Even further in this embodiment, a transaction associated with no benefits results in c₂=c₁.

According to the present invention and the exemplary embodiment described in FIG. 1, taking the sum of the merchant, customer and product or service evaluation, in this example leads to a number or fraction in the range of 0 to 1. The set of evaluations may be updated continuously, periodically, per action etc.

The first transaction or service cost, defined by an agreement between the merchant and the service provider is paid by the merchant to the system provider either once, periodically, per each transaction etc. The cost can be dependable on the operating result of the merchant, a fraction of a transaction, the rating or certificate of the merchant or some other applicable method of determining a cost.

If the first transaction cost is as an example defined as a fraction of the price associated with the product or service provided by the transaction, it may be subtracted from the price of the payment request or it may be invoiced from the merchant's account.

Further, according to the method and system of the present invention and the described embodiment of FIG. 1, the service provider system determines a value by multiplying the value of benefits applicable to the transaction by the sum of the fractions attained from the evaluations, as described above. The resulting value is subtracted from the paid or due first transaction cost of the merchant, resulting either in a refund to the merchant of said value or decrease of due transaction cost invoice by the said value to the merchant. Thus the sum of fractions defines the fraction or percentage of benefits payable with the first transaction cost, resulting in a decreased second transaction.

This reduction in the transaction cost in the present example reflects the evaluated influence of the subscribers and merchants past and present actions. The valuations associated with the predefined influences the system endorses in the present example is subscribers donating received benefits further, merchants contributing to a cumulative pool of benefits directed to beneficiaries and best possible user experi-ence and quality of products or services co-designed between the end user and provider.

The price of the product or service provided in the transaction, optionally the value of the benefits and/or second transaction cost subtracted, as described above, is directed to the merchant.

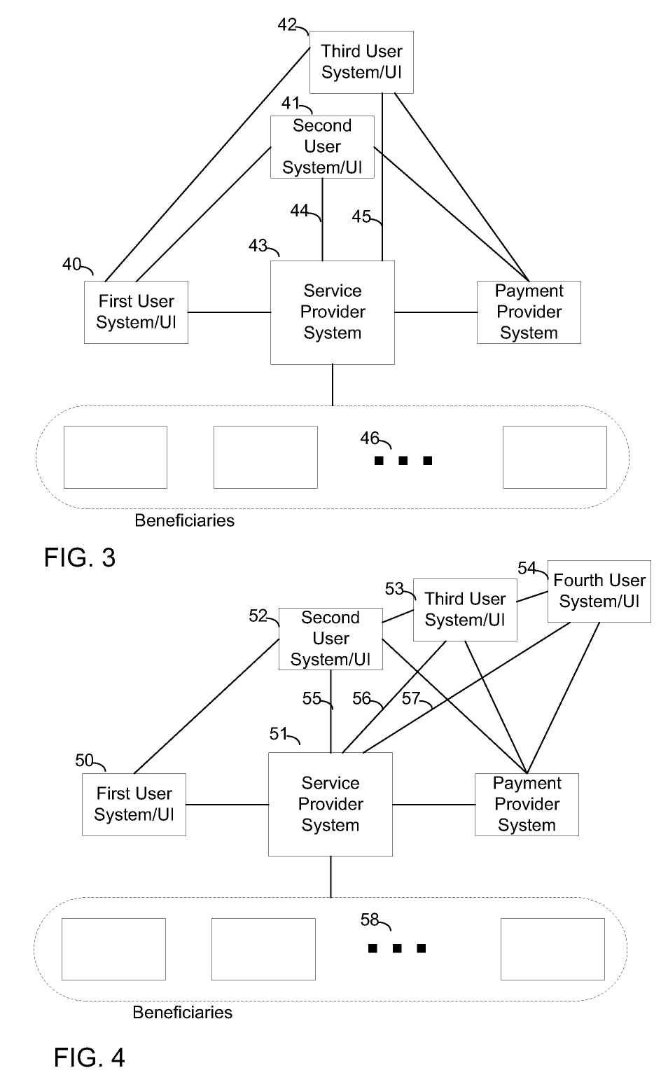

Further, as an exemplary embodiment of the present invention, FIG. 3 illustrated an exemplary utilization of the invention, where the first user 40 initiates a transaction with both second user 41 and third user 42. The service provider system 43 acts as a virtual storefront to support fragmented shopping paths and both transactions 44 and 45 are processed according to the present invention and the teachings of this description to yield two second transaction costs respectively and additional benefit accumulation 46 to existing or new beneficiaries.

Even further, as an exemplary embodiment of the present invention, FIG. 4 illustrated an exemplary utilization of the invention, where a chain of transactions results after the first user 50 has defined a demand in the service provider system 51 and the second user 52, to fulfill the demand and to be able to feasibly supply the described product or service with advantageous benefit development and favorable reflections on its sustainability index, the second user uptakes subcontracting, outsourcing and/or delivery actions with a third user 53 in the service provider system being evaluated to have a high sustainability index and displayed to produce high quality products or services. The second transaction may further create a third transaction between the third user and the fourth user 54 etc., creating a value chain and further opportunity and evaluations in the system according to the present invention. The second transaction cost of each of the transactions 55, 56 and 57 is calculated according to the present invention and the teachings of this description to yield each second transaction cost respectively, with the predefined valuation influence on actions of the parties of the transactions and additional benefit accumulation 58 to existing or new beneficiaries.

As easily understood by the skilled person, the user may initiate one or more transactions according to the examples illustrated in FIG. 3 or FIG. 4 to any extent and in any combination of these.

The scope of the invention is determined by the attached claims together with the equivalents thereof. The skilled persons will again appreciate the fact that the ex-plicitly disclosed embodiments were constructed for illustrative purposes only, and the scope will cover further embodiments, embodiment combinations and equivalents that better suit each particular use case of the invention.

1. A method for determining a cost in an electronic commerce transaction between a first user and a second user, comprising
continuously or periodically assigning one or more values, based on a set of rules, to at least one entity selected from the group consisting of: first user, second user, and a transaction between said first user and second user,
receiving a first user acceptance of a transaction identifying the second user and a first cost and a number of benefits if any, and
calculating a second cost based on the first cost, the number of benefits if any, and one or more values corresponding to at least one entity selected from the group consisting of: the first user, the second user, and the transaction between said first user and second user.

2. The method according to claim 1, further comprising
establishing criteria based on a first user request,
optionally, creating a representation of a demand based on a first user request,
establishing a representation of supply based on one or more user requests, optionally at least one of said one or more user requests being based on a representation of a demand of a first user request,
selecting a set of said supply according to said criteria
communicating said set of supply to the first user, and
receiving said first user acceptance of a transaction based at least partially on a supply in said communicated set of supply, identifying the second user and a first cost and a number of benefits if any.

3. The method according to claim 1, wherein said number of benefits is one or more exchangeable entities each having an exchange value, optionally having at least one property selected from the group consisting of: assigned first recipient, conditions of transfer, conditions of redemption, and conditions of use.

4. The method according to claim 2, wherein said demand comprising criteria for at least one entity selected from the group consisting of: a product, a service, and a benefit.

5. The method according to claim 2, said supply comprising criteria of at least one entity selected from the group consisting of: a product, a service, and a benefit.

6. The method according to claim 2, wherein said criteria comprises at least one entity selected from the group consisting of: price, brand, quality, benefit quantity, benefit quality, and benefit receiver.

7. The method according to claim 1, wherein said first cost is a cost based on an agreement between the second user and a party different from the first user and the second user.

8. The method according to claim 7, wherein said second cost is at least partially transferred to a user in a transaction between a user and said party different from said first user and second user.

9. The method according to claim 1, wherein said set of rules comprises mathematical, logical or semantic mappings assigning one or more values in predetermined ranges to at least one entity selected from the group consisting of: first user, second user, and a transaction between said first user and second user, based on attributes of at least one entity selected from the group consisting of: first user, second user, a transaction between said first user and second user, and a number of benefits if any, associated with a transaction.

10. The method according to claim 9, wherein values of a set of one or more of values selected from said assigned one or more values has a sum in the range from zero to one.

11. The method according to claim 10, wherein said calculation of a second cost comprises
summing the exchange values of said number of benefits if any, to yield a first number greater or equal to zero,
summing the values of said set of one or more of values selected from said assigned one or more values, to yield a second number in the range from zero to one,
multiplying said first number with said second number, to yield a product, and
subtracting said product from said first cost, yielding a second cost.

12. A system for determining a cost in an electronic commerce transaction, comprising
database for storing one or more values for at least one entity selected from the group consisting of: first user, second user, and a transaction between said first user and second user,
an evaluation entity for continuously or periodically assigning one or more values, based on a set of rules, to at least one entity selected from the group consisting of: first user, second user, and a transaction between said first user and second user,
a communication entity for presenting information from said database based on a received user request or a system request and to convey information to said database based on a received user request or a system request,
a payment entity for processing a transaction request based on a first user request accepting a transaction identifying the second user, a first cost and a number of benefits if any, and associated evaluations in said database, said processing comprising a computation of a second cost and a payment transfer.

13. The system according to claim 12, said database further configured for storing at least one entity selected from the group consisting of: user accounts, user information, benefit account, supply information, demand information, benefit information, beneficiary information, and transaction information.

14. The system according to claim 12, wherein said evaluation entity further comprises means for assigning displayable certificates and assessments based on said one or more assigned values.

15. The system according to claim 12, wherein said communication entity further comprises at least one entity selected from the group consisting of:
an interface for establishing criteria based on a first user request,
an interface for creating a representation of a demand based on a first user request,
an interface for establishing a representation of supply,
an interface for displaying representations of supply and demand,
an interface for accepting a transaction identifying the second user and a first cost and a number of benefits,
an interface for creating and using a user account,
an interface for viewing information based at least partly on said assigned values, and
an interface for viewing information based on benefit transfers and accumulation.

16. The system of claim 12, wherein said payment entity further comprises means for managing an user benefit account based on information associated with at least one entity selected from the group consisting of: first user, second user, and a transaction between said first user and second user.

17. The system according to claim 12, wherein said system is located within a website of a facilitator and accessible by a user by means of a personal computer or a mobile electronic device over an a network such as telecommunication, internet, semantic web or other wireless or wired network access and any combination of these constituting an access network.
